(19) United States
(12) Patent Application Publication
(10) Pub. No.: US 2015/0328953 A1
(43) Pub. Date: Nov. 19, 2015

(54) SYSTEMS AND METHODS FOR ENGINE POWER CONTROL FOR TRANSPORT REFRIGERATION SYSTEM

(71) Applicant: THERMO KING CORPORATION, Minneapolis, MN (US)

(72) Inventors: Vladimir SULC, Minnetonka, MN (US); Robert Michael LATTIN, Minneapolis, MN (US); Alan D. GUSTAFSON, Eden Prairie, MN (US); Ryan J. DOTZENROD, Lakeville, MN (US); Gary O. McGINLEY, Minneapolis, MN (US)

(21) Appl. No.: 14/655,164

(22) PCT Filed: Dec. 27, 2013
(86) PCT No.: PCT/US2013/078021

§ 371 Date: Jun. 24, 2015

Related U.S. Application Data
(60) Provisional application No. 61/746,223, filed on Dec. 27, 2012.

(51) Int. Cl. B60H 1/00; B60P 3/20; F25B 49/02

(52) U.S. Cl. CPC B60H 1/00764; F25B 49/022; B60H 1/00364; B60H 1/0045; B60H 1/00878; B60P 3/20

(57) ABSTRACT

Systems and methods are directed to controlling the amount of power supplied by an engine for a transport refrigeration system (TRS). An engine load is estimated and compared with a maximum allowable power supply from an engine. The engine load can be automatically adjusted according to results of the comparison. An automatic adjustment of the amount of power supplied by the engine is provided, to ensure that the engine is operating within a preset window of operation and compliant with emission legislation.

### FIELD OF TECHNOLOGY

The embodiments disclosed herein relate generally to a transport refrigeration system (“TRS”). More particularly, the embodiments disclosed herein relate to controlling the amount of power supplied by an engine of a TRS.

### BACKGROUND

A transport refrigeration system (TRS) is generally used to control an environmental condition (e.g., temperature, humidity, air quality, and the like) within a refrigerated transport unit (e.g., a container on a flat car, an intermodal container, etc.), a truck, a box car, or other similar transport unit (generally referred to as a “refrigerated transport unit”). Refrigerated transport units are commonly used to transport perishable items such as produce, frozen foods, and meat products. Typically, a transport refrigeration unit (TRU) is attached to the refrigerated transport unit to control the environmental condition of the cargo space. The TRU can include, without limitation, a compressor, a condenser, an expansion valve, an evaporator, and fans or blowers to control the heat exchange between the air inside the cargo space and the ambient air outside of the refrigerated transport unit.

Regulations on engine emissions for an engine used in a refrigerated transport unit are becoming more relevant. For example, Tier 4 emission standards of the Environmental Protection Agency (EPA) require that emissions of particulate matter (PM) and oxides of nitrogen (NOx) be further reduced by about 90% compared with previous standards.

### SUMMARY

The embodiments described herein are directed to controlling the amount of active power supplied by an engine of a TRS.

Embodiments described herewith estimate an engine load and compare the estimated engine load with a maximum allowable power supply from the engine at a given revolutions per minute (RPM) of the engine. The engine load is then automatically adjusted according the comparison results. This allows a TRS to control an active engine power supplied to the TRS so that an emission of the engine does not exceed a regulated emission level, for example, the Tier 4 emission standards. Embodiments described herein can prevent an engine of a TRS from exceeding regulated emission levels even when the engine is over or under loaded.

In one embodiment, a method of controlling an amount of active engine power supplied by an engine of a transport refrigeration system (TRS) is provided. The method includes determining a maximum allowable amount of power up to which can be supplied by the engine for the TRS, estimating an active engine load of the engine, and obtaining a difference between the maximum allowable amount of power supplied by the engine and the active engine load. When the difference is within a predetermined window, an amount of power is supplied by the engine to drive the TRS. The amount of power is equal to the active engine load. When the difference is out of the predetermined window, the active engine load is adjusted so that the difference is within the predetermined window.

### BRIEF DESCRIPTION OF THE DRAWINGS

Referring now to the drawings in which like reference numbers represent corresponding parts throughout.

FIG. 1 illustrates a side perspective view of a refrigerated transport unit attached to a tractor, according to one embodiment.

FIG. 2 illustrates a block diagram of a TRS having an engine and a TRS controller for controlling the amount of power supplied by the engine for the TRS, according to one embodiment.

FIG. 3A illustrates a flow diagram of a method of controlling the amount of power supplied by an engine for a TRS, according to one embodiment.

FIG. 3B illustrates a flow diagram of a method of controlling the amount of power supplied by an engine for a TRS, according to another embodiment.

### DETAILED DESCRIPTION

The embodiments described herein are directed to controlling the amount of active power supplied by an engine of a TRS. Embodiments described herewith estimate an engine load and compare the estimated engine load with a maximum allowable power supply from the engine at a given RPM of the engine. The engine load is then automatically adjusted according the comparison results. This allows the TRS to control an active engine power supplied for a TRS so that an emission of the engine does not exceed a regulated emission level, for example, the Tier 4 standards.

In one embodiment, an engine load is estimated and compared with a maximum allowable power supply from an engine. A throttling valve of a compressor of a TRU can be closed to reduce the engine load, or opened to increase the engine load, according to results of the comparison.

The embodiments described herein can provide an automatic adjustment of the amount of active power supplied by an engine, to ensure that the engine is operating within a preset window of operation (e.g., the difference between an engine load and the maximum allowable power supply from the engine is within a preset window) and compliant with emission standards or regulations.

References are made to the accompanying drawings that form a part hereof, and in which is shown by way of illustration of the embodiments in which the methods and systems described herein may be practiced. The term “refrigerated transport unit” generally refers to, for example, a temperature controlled trailer, container, or other type of transport unit, etc. The term “transport refrigeration system” or “TRS” refers to a refrigeration system for controlling the refrigeration of an internal space of the refrigerated transport unit. The term “genset” refers to a generator set which includes an engine and an alternator and/or a generator. In some embodiments, a genset can be located in a TRU. In other embodiments, a genset can be a TRU genset that is separate from a TRU and positioned outside the TRU. The term “alternator” refers to an electromechanical device that is attached to a TRS and converts mechanical energy to electrical energy. An alternator can operatively connect to an engine and a battery and can charge the battery. The term “generator” refers to an electromechanical device that is attached to a TRS and converts mechanical energy to electrical energy. The term “maximum allowable power” refers to a user-defined amount of power supplied by a power source, or a physical maximum amount of power that can be supplied by a power source. The user-defined amount of power can be, for example, the maximum amount of power that can be supplied by a power source and that is compliant with specific emission regulations. The term “engine load” refers to an amount of power that is demanded by component(s) of a TRS at a particular time from an engine of the TRS to run the component(s).

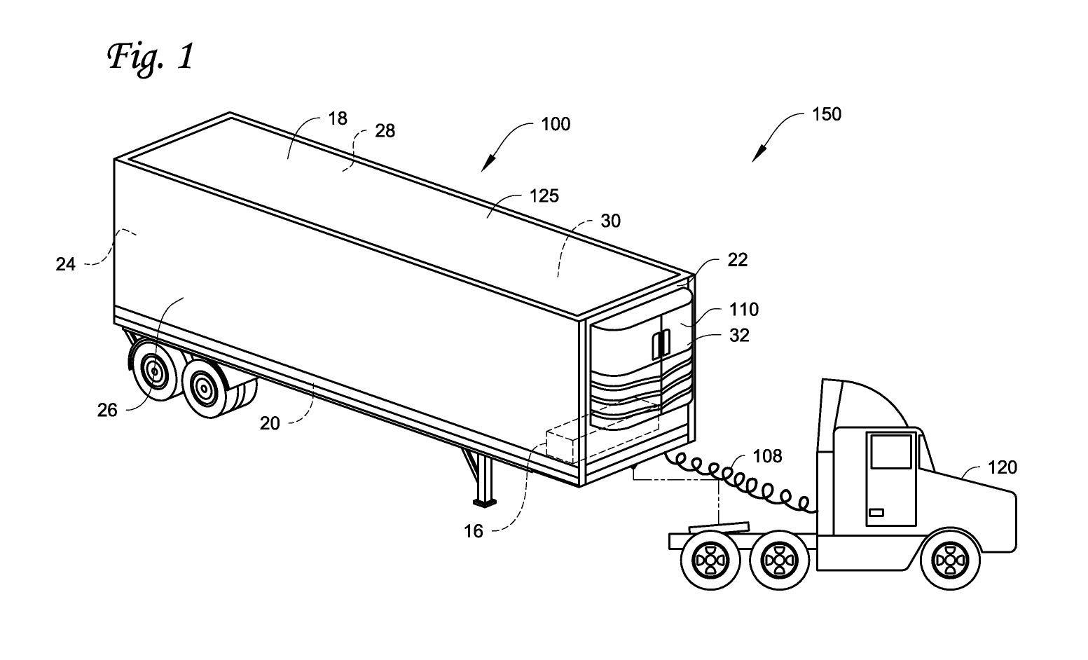

FIG. 1 illustrates one embodiment of a TRS 150 for a refrigerated transport unit 100 that is attached to a tractor 120. The tractor 120 is configured to tow the refrigerated transport unit 100. The refrigerated transport unit 100 includes a transport unit 125 and the TRS 150. The transport unit 125 can be attached to the tractor 120 via a fifth wheel (not shown) of the tractor 120. A flexible electrical connection 108 can connect an alternator (not shown) of the tractor 120 to the TRS 150. In some embodiments, the flexible electrical connection 108 is one or more suzi leads.

The TRS 150 includes a TRU 110 and a generator set (“genset”) 16. The TRU 110 controls refrigeration within the transport unit 125. The genset 16 is separate from the TRU 110, operatively connected to the TRU 110, and supplies power to the TRU 110 and other components of the TRS 150. In some embodiments, the TRS 150 can include the genset 16 to be self-powered.

The transport unit 125 includes a roof 18, a floor 20, a front wall 22, a rear wall 24, and opposing sidewalls 26, 28. The TRU 110 is positioned on the front wall 22 of the transport unit 125. The TRS 150 is configured to transfer heat between a conditioned cargo space 30 and the outside environment.

As shown in FIG. 1, the TRU 110 is enclosed in a housing 32. The TRU 110 is in communication with the cargo space 30 and controls the temperature in the cargo space 30. The TRU 110 includes a closed refrigerant circuit (not shown) that regulates various operating conditions (e.g., temperature, humidity, etc.) of the space 30 based on instructions received from a TRS controller (not shown). The refrigerant circuit can be powered by the genset 16. Generally, the compressor requires the most energy among different components of the TRS 150 and is the primary contributor of the load seen by an engine (not shown) of the genset 16.

The generator set 16 generally includes an engine (not shown), a fuel container (not shown) and a generator (not shown). The engine may be an internal combustion engine (e.g., diesel engine, etc.) that may generally have a cooling system (e.g., water or liquid coolant system), an oil lubrication system, and an electrical system (none shown). An air filtration system (not shown) filters air directed into a combustion chamber (not shown) of the engine. The engine may also be an engine that is configured specifically for the TRS 150. The fuel container is in fluid communication with the engine to deliver a supply of fuel to the engine.

It will be appreciated that the embodiments described herein may be used in any suitable temperature controlled apparatus such as a ship board container, a straight truck, an over the road truck cabin, etc. The TRS may be a vapor-compressor type refrigeration system, or any other suitable refrigeration system that can use refrigerant, cold plate technology, etc.

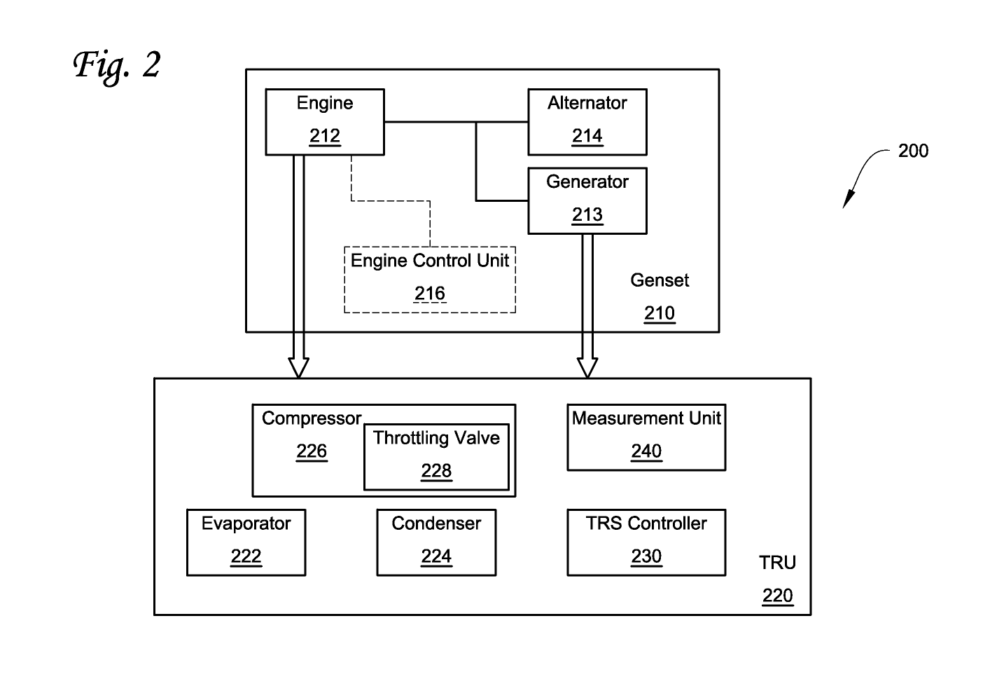

FIG. 2 illustrates a block diagram of a TRS 200 of a refrigerated transport unit such as the refrigerated transport unit 100 shown in FIG. 1, according to one embodiment. The TRS 200 can control a temperature T inside a cargo space (e.g., the cargo space 30 in FIG. 1) of a transport unit (e.g., the transport unit 125 in FIG. 1). The TRS 200 includes a TRU 220 and a genset 210 operatively connected to the TRU 220. The genset 210 is configured to supply power to the TRU 220 and other components of the TRS 200.

The genset 210 includes an engine 212, a generator 213, an alternator 214, and optionally an engine control unit 216. The engine 212 is operatively connected to the TRU 220, the generator 213, and the alternator 214, and configured to provide an amount of power up to a maximum allowable power supply Pₘₐₓ to components of the TRS 200 such as the TRU 220, the generator 213, and the alternator 214. The maximum allowable power supply Pₘₐₓ can be predetermined based on specific emission standards, regulations, etc. In some embodiments, the maximum allowable power supply Pₘₐₓ can be a pre-determined threshold value set so that emission from the engine 212 is compliant with specific emission standards or regulations such as, for example, the Tier 4 emission standards. In some embodiments, the maximum power supply Pₘₐₓ can be associated with revolutions per minute (“RPM”) of the engine 212. In some embodiments, the maximum power supply Pₘₐₓ can be the physical maximum amount of power that can be supplied by the engine 212. The engine 212 can be instructed to run at a desired or given RPM to reach the maximum power supply Pₘₐₓ. In some embodiments, the maximum power supply Pₘₐₓ can be a physical limit that the engine 212 can provide. In some embodiments, the engine 212 can be mechanically governed and can have a power supply capacity higher than Pₘₐₓ.

In some embodiments, the TRS 200 can include an optional altitude sensor (not shown) configured to determine the altitude of the location of the TRS 200. The maximum allowable power supply Pₘₐₓ can be adjusted based on the altitude. In some embodiments, the maximum allowable power supply Pₘₐₓ can be increased, for example, to the physical maximum amount of power that can be supplied by the engine 212 when the TRS 200 is at an altitude at or above which specific emission standards or regulations such as, for example, the Tier 4 emission standards no longer apply.

In some embodiments, the generator 213 can convert mechanical energy from the engine 212 to electrical energy and can require power from the engine 212 to run. For example, the amount of power that can be demanded by the generator 213 from the engine 212 at a particular time can be expressed as a generator load F_{generator}. The generator 213 is also operatively connected to the TRU 220 and configured to provide electrical power to some components of the TRS 200 such as, for example, an evaporator fan and/or a condenser fan of the TRS 200.

In some embodiments, the alternator 214 can convert mechanical energy from the engine 212 to electrical energy and can require power from the engine 212 to run. For example, the amount of power that can be demanded by the alternator 214 from the engine 212 at a particular time can be expressed as an alternator load Fₐₗₜₑᵣₙₐₜₒᵣ. In some embodiments, the alternator 214 can be configured to electrically charge a battery (not shown) of the TRS 200. The battery can provide power for some components of the TRS 200 such as, for example, the engine control unit 216. In some embodiments, the alternator 214 can be operatively connected to the TRU 220 and configured to provide electrical power to some components of the TRS 200.

The TRU 220 includes an evaporator 222, a condenser 224, and a compressor 226, which are operatively connected to a TRS controller 230. The TRS controller 230 is configured to control the amount of active power supplied by the engine 212 for the TRU 220. The evaporator 222, the condenser 224, and the compressor 226 can require power from the engine 212 to run. For example, the amount of power that can be demanded by the evaporator 222, the condenser 224 and the compressor 226 from the engine 212 at a particular time can be respectively expressed as an evaporator load Fₑᵥₐₚₒᵣₐₜₒᵣ, a compressor load F_{compressor}, and a condenser load F_{condenser}.

In some embodiments, the compressor 226 includes a throttling valve 228 for controlling the amount of power demanded by the compressor 226 from the engine 212 to run the compressor 226 (e.g., the compressor load F_{compressor}). In some embodiments, when the throttling valve 228 is closed, the amount of power demanded by the compressor 226 from the engine 212 to run the compressor (e.g., the compressor load F_{compressor}) is reduced. When the throttling valve is open, the amount of power demanded by the compressor 226 from the engine 212 to run the compressor 226 (e.g., the compressor load F_{compressor}) is increased. It is to be understood that the amount of power demanded by the compressor 226 from the engine 212 to run the compressor 226 (e.g., the compressor load F_{compressor}) can be adjusted through means other than a throttling valve.

In some embodiments, components of the TRS 200 may dissipate energy during operation and attribute to an energy loss. The energy loss can include, for example, energy dissipated via a driving belt, a bearing(s), etc., of the TRS 200. It is to be understood that the energy loss is not limited to the energy dissipated via the driving belt, the bearing(s), etc. The energy loss can include any type of energy losses that can occur during the operation of the TRS 200 that can dissipate a portion of the power supplied by the engine 212. An amount of power (e.g., Fₗₒₛₛ) is demanded from the engine 212 to compensate the energy loss that occurs during the operation of the TRS 200. The amount of power (e.g., Fₗₒₛₛ) can include, for example, F_{bearing loss}, and F_{belt loss}, where F_{bearing loss} is the amount power to compensate for energy that is dissipated via one or more bearings of the TRS 200, and F_{belt loss} is the amount power to compensate for energy that is dissipated via the driving belt of the TRS 200.

The TRS 200 further includes a measurement unit 240. The measurement unit 240 can include one or more sensors that are distributed in the TRS 200. In some embodiments, the sensors can be configured to measure a real-time RPM of the engine 212 and real-time system load parameters of components of the TRS 200. Then the sensors can send a signal based on the measurement to the TRS controller 230. A real-time power load from the components of the TRS 200 can be estimated by the TRS controller 230 based on the signal from the sensors. The real-time RPM and system load parameters can be used to estimate the real-time engine load (e.g., the amount of power that is demanded by the TRU 220 and other components of the TRS 200 from the engine 212).

In some embodiments, the real-time system load parameters can include, for example, a suction pressure of the compressor 226, a suction temperature of the compressor 226, a discharge pressure of the compressor 226, a discharge temperature of the compressor 226, an output current from the generator 213, an output current from the alternator 214, etc. In some embodiments, a real-time engine load can be determined by one or more engine parameters such as, for example, an exhaust gas temperature of the engine, a fuel mass flow of the engine, an engine torque, etc.

When the TRS 200 runs, components of the TRS 200 including, for example, the generator 213, the alternator 214, the evaporator 222, the condenser 224, the compressor 226, etc., can respectively demand an amount of power from the active power supplied by the engine 212 at a particular time (e.g., real-time power load from the components of the TRS 200 as seen by the engine 212). The real-time power load from the components of the TRS 200 can be estimated by the TRS controller 230.

In some embodiments, the TRS controller 230 can receive measured real-time system load parameters from, for example, the sensor(s) of the measurement unit 240. The TRS controller 230 then can estimate a real-time engine load from a component of the TRS 220 (e.g., the generator load F_{generator}, the alternator load Fₐₗₜₑᵣₙₐₜₒᵣ, the compressor load F_{compressor}, etc.) based on the received real-time system load parameters.

In some embodiments, the amount of real-time power demand on the engine 212 from the components of the TRS 200 can be estimated by the TRS controller 230 based on pre-defined system load parameters of the components of TRS 200. The pre-defined system load parameters can include, for example, a high speed evaporator fan load, a low speed evaporator fan load, a high speed condenser fan load, a low speed condenser fan load, energy dissipated via a driving belt and/or a bearing(s), margin of safety to account for component variability, etc. In some embodiments, the TRS controller 230 can preset the pre-defined system load parameters for components of the TRS 200. The real-time engine load from a component of the TRS 220 such as, for example, the evaporator load Fₑᵥₐₚₒᵣₐₜₒᵣ, the condenser load F_{condenser}, the load Fₗₒₛₛ, etc., can be estimated by the TRS controller 230 based on the pre-defined system load parameters.

In some embodiments, the TRS controller 230 can combine real-time system load parameters and preset system load parameters for estimating the real-time power load demanded by the components of the TRS 200 such as, for example, the generator load F_{generator}, the alternator load Fₐₗₜₑᵣₙₐₜₒᵣ, the compressor load F_{compressor}, the evaporator load Fₑᵥₐₚₒᵣₐₜₒᵣ, the condenser load F_{condensor}, the load Fₗₒₛₛ, etc.

In some embodiments, the evaporator load Fₑᵥₐₚₒᵣₐₜₒᵣ includes, for example, an evaporator fan power F_{evaporator fan power}. In some embodiments, the condenser load F_{condenser} includes, for example, a condenser fan power F_{condenser fan power}. The evaporator fan power and the condenser fan power can be determined via, for example, a fan speed, an air flow character, etc.

In some embodiments, the evaporator load Fₑᵥₐₚₒᵣₐₜₒᵣ, the compressor load F_{compressor}, the F_{bearing loss}, and the F_{belt loss} each can be a function of the given RPM of the engine and a temperature T of, for example, the temperature in a cargo space (e.g., the cargo space 30 shown in FIG. 1).

In some embodiments, the amount of power demanded by the generator 213 from the engine 212 (e.g., the generator load F_{generator}) can be determined by, for example, the measurement unit 240, via measuring an output current of the generator 213. The generator load F_{generator} can be a function of the output current of the generator 213, a voltage of the generator 213, and the temperature T inside a cargo space (e.g., the cargo space 30 in FIG. 1).

In some embodiments, the amount of power demanded by the alternator 214 from the engine 212 (e.g., the alternator load Fₐₗₜₑᵣₙₐₜₒᵣ) can be determined by, for example, the measurement unit 240, via measuring an output current of the alternator 214. The alternator load Fₐₗₜₑᵣₙₐₜₒᵣ can be a function of the output current of the alternator, a voltage of the alternator, and the temperature T inside a cargo space (e.g., the cargo space 30 in FIG. 1).

In some embodiments, the amount of power demanded by the compressor 226 from the engine 212 to run the compressor 226 (e.g., the compressor load F_{compressor}) can be estimated by the TRS controller 230 as a function of system load parameters such as, for example, the given RPM of the engine, one or more load parameters of the compressor 226, one or more property parameters of refrigerant, etc.

In some embodiments, the load parameters of the compressor 226 can include, for example, a suction pressure of the compressor 226, a suction temperature of the compressor 226, a discharge pressure of the compressor 226, a discharge temperature of the compressor 226, a RPM of the compressor 226, etc. The suction pressure of the compressor 226, the suction temperature of the compressor 226, the discharge pressure of the compressor 226, and the discharge temperature of the compressor 226 can be respectively measured by one or more sensors of the measurement unit 240.

In some embodiments, the RPM of the compressor 226 can be determined via a pulley ratio of the compressor 226 and the RPM of the engine 212. In some embodiments, the RPM of the compressor 226 can be determined via an input frequency and a slip percentage of the compressor 226.

In some embodiments, the property parameters of refrigerant can include, for example, thermodynamic and transport properties of the refrigerant such as, for example, a specific heat, a pressure, a temperature, etc.

In some embodiments, the amount of power demanded by the compressor 226 from the engine 212 to run the compressor 226 (e.g., the compressor load F_{compressor}) can be estimated by the TRS controller 230 based on a polynomial function such as, for example, F_{condenser}=a1−(a2×pd)+(a3×RPM+4.11638×10⁻⁵×ps²)+(a3×pd²)+(a4×ps×pd)−(a5×ps×pd²)+(a6×ps²×pd²)−(a7×ps² ×RPM)+(a8×pd×RPM)+(a9×pd×RPM²)−(a10×pd²×RPM²)+(a12×ps×pd×RPM), where a1 to a12 are parameters that are related to the TRS 200 and may vary based on respective components of the TRS 200, ps is a suction pressure of the compressor, pd is a discharge pressure of the compressor, and RPM is the given RPM of the engine. It is to be understood that in other embodiments, the compressor load F_{compressor} can be estimated based on the given RPM of the engine, and the suction pressure and the discharge pressure of the compressor can be based on a function other than a polynomial function.

In some embodiments, an engine load at a given RPM of the engine can be estimated by the TRS controller 230 by summing up the respective real-time power load from components of the TRS 200. In some embodiments, the load of the engine can be estimated by summing up, for example, Fₑᵥₐₚₒᵣₐₜₒᵣ, F_{condenser}, F_{compressor}, F_{generator}, Fₐₗₜₑᵣₙₐₜₒᵣ, Fₗₒₛₛ, etc.

In some embodiments, an engine load (F_{TRS-LOAD}) from the TRS 200 can be estimated by the TRS controller 230 through the following equation

F_{TRS-LOAD}=Fₑᵥₐₚₒᵣₐₜₒᵣ+F_{condenser}+F_{compressor}+F_{bearing loss}+F_{belt loss}+F_{generator}+Fₐₗₜₑᵣₙₐₜₒᵣ+F_{reserve power}

where Fₑᵥₐₚₒᵣₐₜₒᵣ is the amount of power demanded by the evaporator 222 from the engine 212, F_{compressor} is the amount of power demanded by the compressor 226 from the engine 212, F_{condenser} is the amount of power demanded by the condenser 224 from the engine 212, F_{generator} is the amount of power demanded by the generator 213 from the engine 212, and Fₐₗₜₑᵣₙₐₜₒᵣ is the amount of power demanded by the alternator 214 from the engine 212, F_{bearing loss}+F_{belt loss} is the amount of power to compensate the energy dissipated via the driving belt and the bearing(s) of the TRS 200, and F_{reserve power} is a power load corresponding to additional margin of safety to account for component variability.

The estimated engine load F_{TRS-LOAD} can then be compared with the maximum allowable power supply Pₘₐₓ of the engine 212 by the TRS controller 230. When the estimated engine load F_{TRS-LOAD} is higher than the maximum allowable power supply Pₘₐₓ, the engine load F_{TRS-LOAD} can be reduced by, for example, reducing one or more of the compressor load F_{compressor}, the generator load F_{generator}, and/or the alternator load Fₐₗₜₑᵣₙₐₜₒᵣ. When the estimated engine load F_{TRS-LOAD} is lower than the maximum allowable power supply Pₘₐₓ, the engine load F_{TRS-LOAD} can be increased by, for example, increasing the compressor load F_{compressor} and/or the alternator load Fₐₗₜₑᵣₙₐₜₒᵣ. In this way, the real-time engine load F_{TRS-LOAD} can be maintained at about the maximum allowable power supply Pₘₐₓ of the engine 212. The engine 212 can provide a maximum engine performance while being compliant with specific emission regulations or standards.

In some embodiments, the F_{compressor} can be a primary portion of the F_{TRS-LOAD}, the F_{generator}+Fₐₗₜₑᵣₙₐₜₒᵣ can be a secondary portion of the F_{TRS-LOAD}, the Fₑᵥₐₚₒᵣₐₜₒᵣ+F_{condenser} can be tertiary portion of the F_{TRS-LOAD}, and the F_{bearing loss}+F_{belt loss} can be the least portion of the F_{TRS-LOAD}. In some embodiments, the components of the F_{TRS-LOAD}, i.e., the respective amounts of power demanded by the components of the TRS 200, can be user-defined and adjusted according to user's requirements.

In some embodiments, the engine load F_{TRS-LOAD} can be adjusted by adjusting one or more of the compressor load F_{compressor}, the generator load F_{generator}, and the alternator load Fₐₗₜₑᵣₙₐₜₒᵣ. In other embodiments, the engine load F_{TRS-LOAD} can be adjusted by adjusting the amount of active power that is demanded by a component of the TRS 200 other than the compressor 226, the generator 213, and the alternator 214 from the engine 212.

In some embodiments, when the estimated engine load F_{TRS-LOAD} is higher than the maximum allowable power supply Pₘₐₓ, the engine load F_{TRS-LOAD} can be adjusted by lowering the generator load F_{generator}, and/or the alternator load Fₐₗₜₑᵣₙₐₜₒᵣ while keeping the compressor load F_{compressor}. In some embodiments, an alternator output current of the alternator 214 for charging a battery can be reduced to compensate for the power requirement from the compressor 226. In some embodiments, a generator output current of the generator 213 can be limited under an upper level to allow more power from the engine 212 to be supplied to the compressor 226.

In some embodiments, the compressor load F_{compressor} can be adjusted by, for example, opening or closing the throttling valve 228 via the control of the TRS controller 230. In some embodiments, the generator load F_{generator} can be adjusted by, for example, controlling the generator output current via the control of the TRS controller 230. In some embodiments, the alternator load Fₐₗₜₑᵣₙₐₜₒᵣ can be adjusted by, for example, controlling the alternator output current via the control of the TRS controller 230.

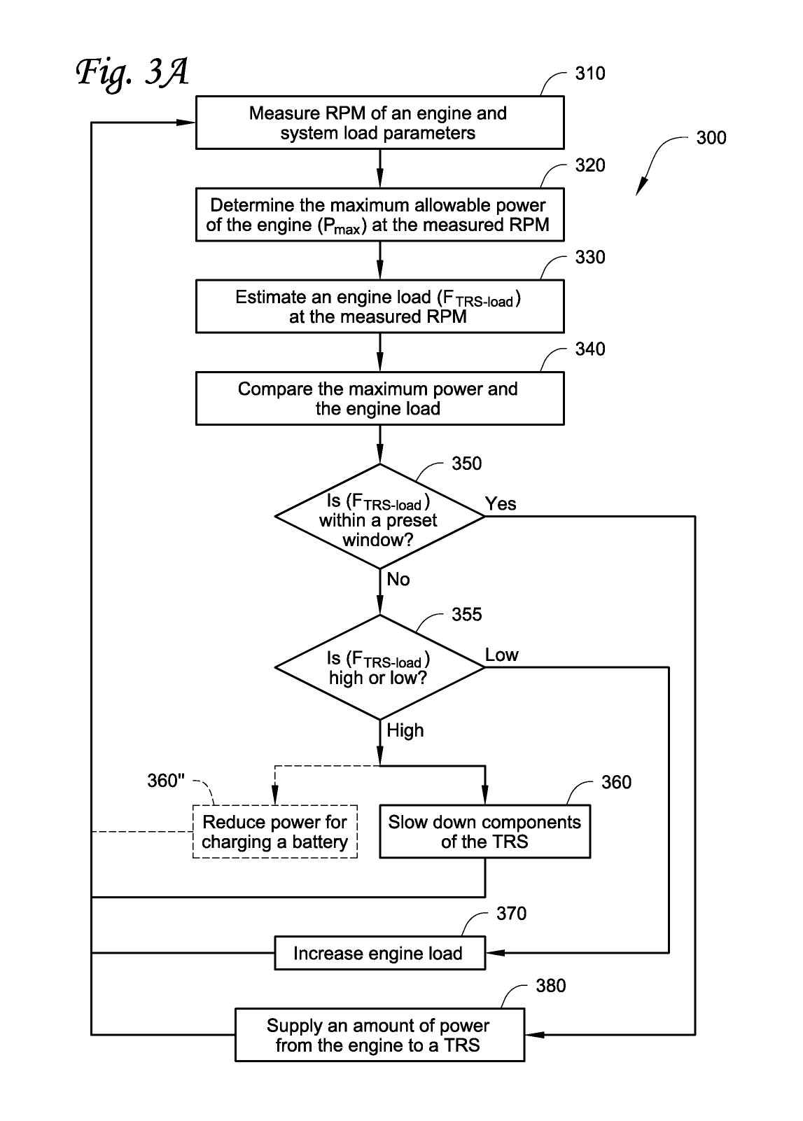

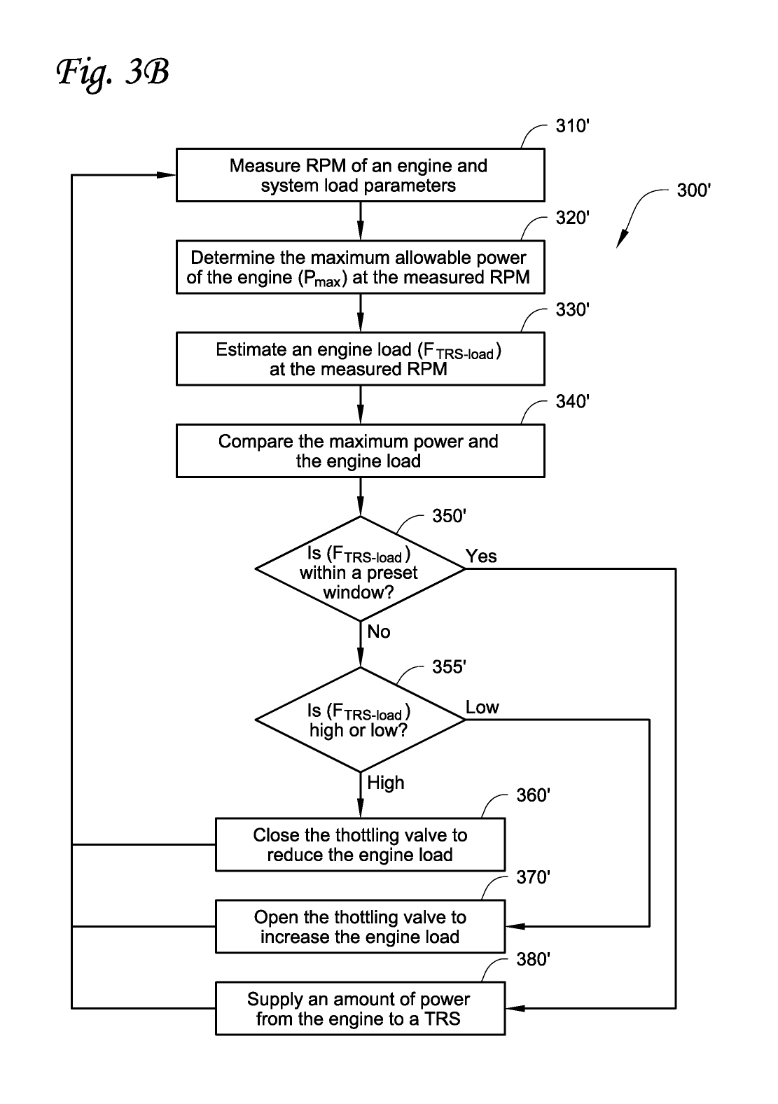

FIG. 3A illustrates a flow diagram of a method 300 of controlling an active engine power supplied by the engine 212 for the TRS 200, according to one embodiment. At 310, a RPM of the engine 212 and real-time system load parameters are measured by the measurement unit 240. In some embodiments, the real-time system load parameters can include, for example, a suction pressure of the compressor 226, a suction temperature of the compressor 226, a discharge pressure of the compressor 226, a discharge temperature of the compressor 226, a RPM of the compressor 226, etc. Optionally, in some embodiments, the real-time system load parameters can also include an output current of the generator 213 and/or an output current of the alternator 214. The method then proceeds to 320.

At 320, the maximum allowable power supply Pₘₐₓ of the engine 212 at the measured RPM is determined by, for example, the TRS controller 230. The maximum allowable power supply Pₘₐₓ can be determined according to specific emission regulations. The maximum allowable power supply Pₘₐₓ can be a function of the measured RPM of the engine 212. In some embodiments, the TRS controller 230 can receive the measured RPM of the engine 212 and determine the maximum allowable power supply Pₘₐₓ based on the RPM. In some embodiments, the maximum allowable power supply Pₘₐₓ can be preset by the TRS controller 230. The method then proceeds to 330. In some embodiments, the maximum allowable power supply Pₘₐₓ can be a physical maximum amount of power that can be supplied by the engine 212.

At 330, an engine load F_{TRS-LOAD} at the measured RPM is estimated by, for example, the TRS controller 230. In some embodiments, the engine load F_{TRS-LOAD} can be estimated by the TRS controller 230 through the following equation

F_{TRS-LOAD}=Fₑᵥₐₚₒᵣₐₜₒᵣ+F_{condenser}+F_{compressor}+F_{bearing loss}+F_{belt loss}+F_{generator}+Fₐₗₜₑᵣₙₐₜₒᵣ+F_{reserve power},

where Fₑᵥₐₚₒᵣₐₜₒᵣ is the amount of power demanded by the evaporator 222 from the engine 212 to run the evaporator 222, F_{compressor} is the amount of power demanded by the compressor 226 from the engine 212 to run the compressor 226, F_{condenser} is the amount of power demanded by the condenser 224 from the engine 212 to run the condenser 224, F_{generator} is the amount of power demanded by the generator 213 from the engine 212, Fₐₗₜₑᵣₙₐₜₒᵣ is the amount of power demanded by the alternator 214 from the engine 212, F_{bearing loss}+F_{belt loss} is the amount of power to compensate the energy dissipated by the driving belt and the bearing(s) of the TRS 200, and F_{reserve power} is a power load corresponding to additional margin of safety to account for component variability. Each of Fₑᵥₐₚₒᵣₐₜₒᵣ, F_{condenser}, F_{compressor}, F_{bearing loss}+F_{belt loss}, F_{generator}, Fₐₗₜₑᵣₙₐₜₒᵣ, F_{reserve power} can be respectively estimated by the TRS controller 230. The method 300 then proceeds to 340.

At 340, the maximum power Pₘₐₓ of the engine 212 at the measured RPM and the engine load F_{TRS-LOAD} at the measured RPM are compared by the TRS controller 230. The method 300 then proceeds to 350.

At 350, the TRS controller 230 determines whether the amount of active power demanded by the TRU 220, the generator 213, the alternator 214 and/or other components of the TRS 200 (e.g., the real-time engine load F_{TRS-LOAD}) is within a predetermined window with respect to the maximum power Pₘₐₓ. This is to determine whether the real-time engine load F_{TRS-LOAD} exceeds or is below predetermined limits. In one embodiment, the TRS controller 230 determines whether the difference between the real-time engine load F_{TRS-LOAD} and the maximum power Pₘₐₓ or |F_{TRS-LOAD}−Pₘₐₓ| is greater than a predetermined value V. If the real-time engine load F_{TRS-LOAD} is out of the predetermined window (e.g., the difference between the real-time engine load F_{TRS-LOAD} and the maximum power Pₘₐₓ is greater than the predetermined value V), the method 300 proceeds to 355. If the real-time engine load F_{TRS-LOAD} is within the predetermined window (e.g., the difference between the real-time engine load F_{TRS-LOAD} and the maximum power Pₘₐₓ is not greater than the predetermined value V), the methods proceeds to 380. In some embodiments, the predetermined value V is about zero. In other embodiments, the predetermined window for the engine load can be defined as (Pₘₐₓ−V₁)≦F_{TRS-LOAD}≦(Pₘₐₓ+V₂) where V₁ and V₂ can have different values.

At 355, when the real-time engine load F_{TRS-LOAD} is out of the predetermined window, the TRS controller 230 determines whether the real-time engine load F_{TRS-LOAD} is higher or lower than the maximum power Pₘₐₓ. If the real-time engine load F_{TRS-LOAD} is higher than the maximum power Pₘₐₓ (e.g., F_{TRS-LOAD}−Pₘₐₓ>V), the method 300 proceeds to 360 or optional 360″. Whether the method 300 proceeds to 360, the optional 36″, or both of 360 and 360″ can be determined by, for example, user requirements. If the real-time engine load F_{TRS-LOAD} is lower than the maximum power Pₘₐₓ (e.g., Pₘₐₓ−F_{TRS-LOAD}>V), the method 300 proceeds to 370.

At 360, the amount of power demanded by the components of the TRS 200 is higher than an upper limit of the allowable power supply from the engine 212 (i.e., the amount of power demanded by the TRS 200 is greater than the maximum allowable amount of power that can be supplied by the engine 212 at a given RPM), the TRS controller 230 reduces the amount of power demanded by the components of the TRS 200 from the engine 212 and to reduce the engine load F_{TRS-LOAD}. In some embodiments, the compressor 226, an evaporator fan of the evaporator 222, a condenser fan of the condenser 224, and/or a mass flow of refrigerant can be slow down to reduce the amount of power demanded by the respective components of the TRS 200 from the engine 212. In some embodiments, the engine load F_{TRS-LOAD} can be reduced by decreasing the amount of power demanded by the alternator 214 from the engine 212, e.g., the alternator load Fₐₗₜₑᵣₙₐₜₒᵣ, to charge a battery of the TRS 200, without reducing the amount of power demanded by other components of the TRS 200 such as, for example, the compressor 226. In some embodiments, the engine load F_{TRS-LOAD} can be reduced by limiting an output current of the generator 213 to decrease the generator load F_{generator}, without slowing down other components of the TRS 200 such as, for example, the compressor 226. The method 300 then proceeds to 310.

At 360, the TRS controller 230 can reduce the amount of power demanded by the components of the TRS 200 from the engine 212 and to reduce the engine load F_{TRS-LOAD} in various ways. In some embodiments, the TRS controller 230 can reduce the amount of power demanded by one or more of the components of the TRS 200 at the same time. In some embodiments, at 360, the TRS controller 230 can first reduce the amount of power demanded by a first component of the TRS 200 such as, for example, the compressor 226, without reducing the amount of power demanded by other components of the TRS 200. Then the TRS controller 230 determines whether the real-time engine load F_{TRS-LOAD} is within a predetermined window with respect to the maximum power Pₘₐₓ. When the amount of power demanded by the components of the TRS 200 is still higher than an upper limit of the allowable power supply from the engine 212, the TRS controller 230 can further reduce the amount of power demanded by the first component, or reduce the amount of power demanded by a second component of the TRS 200.

At optional 360″, the TRS controller 230 reduces the engine load F_{TRS-LOAD} by decreasing the amount of power demanded by, for example, the alternator 214 from the engine 212, to charge a battery of the TRS 200. The method 300 then proceeds to 310. While the embodiment of FIG. 3A shows the optional 360″, it will be appreciated that in some embodiments, the TRS controller 230 can reduce the engine load F_{TRS-LOAD} by reducing the amount of power demanded by the components of the TRS 200 from the engine 212 at 360, and by decreasing the amount of power demanded by, for example, the alternator 214 from the engine 212, to charge a battery of the TRS 200 at 360″ at the same time.

At 370, the amount of power demanded by the components of the TRS 200 is lower than a lower limit of the allowable power supply from the engine 212 (i.e., the maximum allowable amount of power that can be supplied by the engine 212 at a given RPM is substantially greater than the amount of power demanded by the TRS 200), the TRS controller 230 increases the amount of power demanded by the compressor 226 from the engine 212, and to increase the engine load F_{TRS-LOAD}. In some embodiments, the engine load F_{TRS-LOAD} can be increased by increasing the amount of power demanded by, for example, one or more of the compressor 226, the generator 213 and the alternator 214 from the engine 212, or the amount of power demanded by other component(s) of the TRS 200 from the engine 212. The method 300 then proceeds to 310.

When the real-time engine load F_{TRS-LOAD} is within the predetermined window with respect to the maximum power Pₘₐₓ (i.e., the maximum amount of allowable power that can be supplied by the engine 212 at a given RPM is substantially the same amount of power demanded by the TRS 200), the method 300 proceeds to 380. In some embodiments, the real-time engine load F_{TRS-LOAD} is within the predetermined window with respect to the maximum power Pₘₐₓ, when the equation |F_{TRS-LOAD}−Pₘₐₓ|≦V is satisfied. At 380, the engine 212 supplies the amount of active power for the TRS 200. In some embodiments, the amount of power supplied by the engine 212 for the TRS 200 can substantially equate to the engine load F_{TRS-LOAD}.

FIG. 3B illustrates a flow diagram of a method 300′ of controlling an active engine power supplied by the engine 212 for the TRS 200, according to another embodiment. At 310′, a RPM of the engine 212 and real-time system load parameters are measured by the measurement unit 240. In some embodiments, the real-time system load parameters can include, for example, a suction pressure of the compressor 226, a suction temperature of the compressor 226, a discharge pressure of the compressor 226, a discharge temperature of the compressor 226, a RPM of the compressor 226, etc. Optionally, in some embodiments, the real-time system load parameters can also include an output current of the generator 213 and/or an output current of the alternator 214. The method 300′ then proceeds to 320′.

At 320′, the maximum allowable power supply Pₘₐₓ of the engine 212 at the measured RPM is determined by, for example, the TRS controller 230. The maximum allowable power supply Pₘₐₓ can be determined according to specific emission regulations. The maximum allowable power supply Pₘₐₓ can be a function of the measured RPM of the engine 212. In some embodiments, the TRS controller 230 can receive the measured RPM of the engine 212 and determine the maximum allowable power supply Pₘₐₓ based on the RPM. In some embodiments, the maximum allowable power supply Pₘₐₓ can be preset by the TRS controller 230. The method then proceeds to 330.

At 330′, an engine load F_{TRS-LOAD} at the measured RPM is estimated by, for example, the TRS controller 230. In some embodiments, the engine load F_{TRS-LOAD} can be estimated by the TRS controller 230 through the following equation

F_{TRS-LOAD}=Fₑᵥₐₚₒᵣₐₜₒᵣ+F_{condenser}+F_{compressor}+F_{bearing loss}+F_{belt loss}+F_{generator}+Fₐₗₜₑᵣₙₐₜₒᵣ+F_{reserve power},

where Fₑᵥₐₚₒᵣₐₜₒᵣ is the amount of power demanded by the evaporator 222 from the engine 212 to run the evaporator 222, F_{compressor} is the amount of power demanded by the compressor 226 from the engine 212 to run the compressor 226, F_{condenser} is the amount of power demanded by the condenser 224 from the engine 212 to run the condenser 224, F_{generator} is the amount of power demanded by the generator 213 from the engine 212, Fₐₗₜₑᵣₙₐₜₒᵣ is the amount of power demanded by the alternator 214 from the engine 212, F_{bearing loss}+F_{belt loss} is the amount of power to compensate the energy dissipated by the driving belt and the bearing(s) of the TRS 200, and F_{reserve power} is a power load corresponding to additional margin of safety to account for component variability. Each of Fₑᵥₐₚₒᵣₐₜₒᵣ, F_{condenser}, F_{compressor}, F_{bearing loss}+F_{belt loss}, F_{generator}, Fₐₗₜₑᵣₙₐₜₒᵣ, F_{reserve power} can be respectively estimated by the TRS controller 230. The method 300′ then proceeds to 340′.

At 340′, the maximum power Pₘₐₓ of the engine 212 at the measured RPM and the engine load F_{TRS-LOAD} at the measured RPM are compared by the TRS controller 230. The method 300′ then proceeds to 350′.

At 350′, the TRS controller 230 determines whether the amount of active power demanded by the TRU 220, the alternator 214 and/or other components of the TRS 200 (e.g., the real-time engine load F_{TRS-LOAD}) is within a predetermined window with respect to the maximum power Pₘₐₓ. This is to determine whether the real-time engine load F_{TRS-LOAD} exceeds or is below predetermined limits. In one embodiment, the TRS controller 230 determines whether the difference between the real-time engine load F_{TRS-LOAD} and the maximum power Pₘₐₓ or |F_{TRS-LOAD}−Pₘₐₓ| is greater than a predetermined value V. If the real-time engine load F_{TRS-LOAD} is out of the predetermined window (e.g., the difference between the real-time engine load F_{TRS-LOAD} and the maximum power Pₘₐₓ is greater than the predetermined value V), the method 300′ proceeds to 355. If the real-time engine load F_{TRS-LOAD} is within the predetermined window (e.g., the difference between the real-time engine load F_{TRS-LOAD} and the maximum power Pₘₐₓ is not greater than the predetermined value V), the methods proceeds to 380. In some embodiments, the predetermined value V is about zero. In other embodiments, the predetermined window for the engine load can be defined as (Pₘₐₓ−V₁)≦F_{TRS-LOAD}≦(Pₘₐₓ+V₂) where V₁ and V₂ can have different values.

At 355′, when the real-time engine load F_{TRS-LOAD} is out of the predetermined window, the TRS controller 230 determines whether the real-time engine load F_{TRS-LOAD} is higher or lower than the maximum power Pₘₐₓ. If the real-time engine load F_{TRS-LOAD} is higher than the maximum power Pₘₐₓ (e.g., F_{TRS-LOAD}−Pₘₐₓ>V), the method 300′ proceeds to 360′. If the real-time engine load F_{TRS-LOAD} is lower than the maximum power Pₘₐₓ (e.g., Pₘₐₓ−F_{TRS-LOAD}>V), the method 300′ proceeds to 370′.

At 360′, the amount of power demanded by the components of the TRS 200 is higher than an upper limit of the allowable power supply from the engine 212 (i.e., the amount of power demanded by the TRS 200 is greater than the maximum allowable amount of power that can be supplied by the engine 212 at a given RPM), the TRS controller 230 closes the throttling valve 228 to reduce the amount of power demanded by the compressor 226 from the engine 212 to run the compressor 226, e.g., the compressor load F_{compressor}, and to reduce the engine load F_{TRS-LOAD}. It is to be understood that in other embodiments, the engine load F_{TRS-LOAD} can be reduced by decreasing the amount of power demanded by the alternator 214 from the engine 212, e.g., the alternator load Fₐₗₜₑᵣₙₐₜₒᵣ, or the amount of power demanded by other component(s) of the TRS 200 from the engine 212. The method 300′ then proceeds to 310′.

At 370′, the amount of power demanded by the components of the TRS 200 is lower than a lower limit of the allowable power supply from the engine 212 (i.e., the maximum allowable amount of power that can be supplied by the engine 212 at a given RPM is substantially greater than the amount of power demanded by the TRS 200), the TRS controller 230 opens the throttling valve 228 to increase the amount of power demanded by the compressor 226 from the engine 212 to run the compressor 226, e.g., compressor load F_{compressor}, and to increase the engine load F_{TRS-LOAD}. It is to be understood that in other embodiments, the engine load F_{TRS-LOAD} can be increased by increasing the amount of power demanded by the alternator 214 from the engine 212, e.g., the alternator load Fₐₗₜₑᵣₙₐₜₒᵣ, or the amount of power demanded by other component(s) of the TRS 200 from the engine 212. The method 300′ then proceeds to 310′.

When the real-time engine load F_{TRS-LOAD} is within the predetermined window with respect to the maximum power Pₘₐₓ (i.e., the maximum amount of allowable power that can be supplied by the engine 212 at a given RPM is substantially the same amount of power demanded by the TRS 200), the method 300′ proceeds to 380′. In some embodiments, the real-time engine load F_{TRS-LOAD} is within the predetermined window with respect to the maximum power Pₘₐₓ, when the equation |F_{TRS-LOAD}−Pₘₐₓ|≦V is satisfied. At 380′, the engine 212 supplies the amount of active power for the TRS 200. In some embodiments, the amount of power supplied by the engine 212 for the TRS 200 can substantially equate to the engine load F_{TRS-LOAD}.

Optionally, in some embodiments, the methods 300 and/or 300′ can further include a step of stabilizing the amount of power supplied by the engine to drive the TRS by applying the equation to a control loop. The control loop can be, for example, a proportional-integral-derivative (PID) control loop.

### Aspects:

It is noted that any of aspects 1-20 below can be combined with any of aspects 21-24.
Aspect 1. A method of automatically controlling an amount of active engine power supplied by an engine to a transport refrigeration system (TRS), the method comprising:

determining a maximum allowable amount of power supplied by the engine for operating the TRS;

estimating an engine load of the engine;

obtaining a difference between the maximum allowable amount of power supplied by the engine and the engine load; and

adjusting the engine load based on the difference.
Aspect 2. The method of aspect 1, wherein estimating the engine load of the engine includes summing up system loads demanded by one or more components of the TRS.
Aspect 3. The method of aspect 2, wherein the system loads include one or more of a compressor load, an alternator load, a generator load, an evaporator load, a condenser load, and an amount of power to compensate energy dissipation.
Aspect 4. The method of any of aspects 1-3, wherein adjusting the engine load includes:

when the difference is within a predetermined window, supplying an amount of power by the engine to drive the TRS, the amount of power being equal to the engine load; and

when the difference is out of the predetermined window, adjusting the engine load so that the difference is within the predetermined window
Aspect 5. The method of any of aspects 1-4, further comprising measuring revolutions per minute (RPM) of the engine to determine the maximum allowable amount of power at the measured RPM, and to estimate the engine load at the measured RPM.
Aspect 6. The method of any of aspects 1-5, further comprising determining one or more pre-defined system load parameters including at least one of a compressor load of a compressor, an evaporator fan power load of an evaporator fan, a condenser fan power load of a condenser fan, and energy dissipated via a driving belt and a bearing(s), to estimate the engine load.
Aspect 7. The method of any of aspects 1-6, further comprising determining a generator load of a generator to estimate the engine load.
Aspect 8. The method of any of aspects 1-7, further comprising determining an alternator load of an alternator to estimate the engine load.
Aspect 9. The method of any of aspects 1-8, further comprising measuring real-time system load parameters to estimate the engine load.
Aspect 10. The method of aspect 9, wherein measuring real-time system load parameters comprises measuring at least one of a compressor suction pressure, a compressor suction temperature, a compressor discharge pressure, and a compressor discharge temperature of the compressor to determine a compressor load.
Aspect 11. The method of any of aspects 9-10, wherein measuring real-time system load parameters comprises measuring a generator output current to determine a generator load of the generator.
Aspect 12. The method of any of aspects 9-11, wherein measuring real-time system load parameters comprises measuring an alternator output current to determine an alternator load of the alternator.
Aspect 13. The method of any of aspects 1-12, wherein adjusting the engine load comprises:

when the engine load is greater than the maximum allowable amount of power supplied by the engine, reducing an amount of power demanded by one or more components of the TRS.
Aspect 14. The method of any of aspects 1-13, wherein adjusting the engine load comprises:

when the engine load is greater than the maximum allowable amount of power supplied by the engine, reducing the amount of power demanded by an alternator for charging a battery to reduce the engine load without slowing down a compressor of the TRS.
Aspect 15. The method of any of aspects 1-14, wherein adjusting the engine load comprises:

when the engine load is greater than the maximum allowable amount of power supplied by the engine, closing a throttling valve to reduce the engine load; and

when the engine load is lower than the maximum allowable amount of power supplied by the engine, opening the throttling valve to increase the engine load.
Aspect 16. The method of any of aspects 1-15, wherein adjusting the engine load comprises adjusting via changing at least one of a position of a throttling valve, a compressor suction pressure, a compressor suction temperature, a compressor discharge pressure, a compressor discharge temperature, and a compressor mass flow.
Aspect 17. The method of any of aspects 1-16, further comprising measuring the temperature within a cargo space, to estimate the engine load.
Aspect 18. The method of any of aspects 1-17, further comprising stabilizing the amount of power supplied by the engine to drive the TRS by applying the equation to a control loop.
Aspect 19. The method of aspect 18, wherein the control loop is a proportional-integral-derivative (PID) control loop.
Aspect 20. The method of any of aspects 1-19, wherein the components of the TRS include one or more of a compressor, a condenser, an evaporator, a generator, and an alternator.
Aspect 21. A system of automatically controlling an amount of active engine power supplied by an engine to a transport refrigeration system (TRS), the system comprising:

a TRS controller configured to determine a maximum allowable amount of power supplied by the engine for operating the TRS,

the TRS controller configured to estimate an engine load of the engine by summing up system loads demanded by components of the TRS,

the TRS controller configured to obtain a difference between the maximum allowable amount of power supplied by the engine and the engine load, and

the TRS controller configured to adjust the engine load based on the difference between the maximum allowable amount of power supplied by the engine and the engine load.
Aspect 22. The system of aspect 21, wherein the system loads includes one or more of a compressor load, an alternator load, a generator load, an evaporator load, a condenser load, and an amount of power to compensate energy dissipation.
Aspect 23. The system of any of aspects 21-22, further comprising a measurement unit configured to measure revolutions per minute (RPM) of the engine, the TRS controller determines the maximum allowable amount of power at the measured RPM, and to estimate the engine load at the measured RPM.
Aspect 24. The system of aspect 23, wherein the measurement unit includes one or more sensors configure to measure real-time system load parameters, and the TRS controller estimates the engine load based on measure real-time system load parameters.

With regard to the foregoing description, it is to be understood that changes may be made in detail, especially in matters of the construction materials employed and the shape, size and arrangement of the parts without departing from the scope of the present invention. It is intended that the specification and depicted embodiment to be considered exemplary only, with a true scope and spirit of the invention being indicated by the broad meaning of the claims.

1. A method of automatically controlling an amount of active engine power supplied by an engine to a transport refrigeration system (TRS), the method comprising:
determining a maximum allowable amount of power supplied by the engine for operating the TRS;
estimating an engine load of the engine by summing up system loads demanded by components of the TRS;
obtaining a difference between the maximum allowable amount of power supplied by the engine from the engine load;
when the difference is within a predetermined window, supplying an amount of power by the engine to drive the TRS, the amount of power being equal to the engine load; and
when the difference is out of the predetermined window, adjusting the engine load so that the difference is within the predetermined window.

2. The method of claim 1, further comprising measuring revolutions per minute (RPM) of the engine to determine the maximum allowable amount of power at the measured RPM, and to estimate the engine load at the measured RPM.

3. The method of claim 1, further comprising determining one or more pre-defined system load parameters including at least one of a compressor load of a compressor, an evaporator fan power load of an evaporator fan, a condenser fan power load of a condenser fan, and energy dissipated via a driving belt and a bearing(s), to estimate the engine load.

4. The method of claim 1, further comprising determining an alternator load to estimate the engine load.

5. The method of claim 1, further comprising measuring real-time system load parameters to estimate the engine load.

6. The method of claim 5, wherein measuring real-time system load parameters comprises measuring a compressor suction pressure and a compressor discharge pressure of the compressor to determine a compressor load.

7. The method of claim 5, wherein measuring real-time system load parameters comprises measuring an alternator output current to determine an alternator load of the alternator.

8. The method of claim 1, wherein adjusting the engine load comprises:
when the engine load is greater than the maximum allowable amount of power supplied by the engine, closing a throttling valve to reduce the engine load; and
when the engine load is lower than the maximum allowable amount of power supplied by the engine, opening the throttling valve to increase the engine load.

9. The method of claim 1, wherein adjusting the engine load comprises adjusting via changing a position of a throttling valve, a compressor suction pressure, a compressor mass flow, and a discharge pressure of a compressor.

10. The method of claim 1, further comprising measuring the temperature within a cargo space, to estimate the engine load.

11. The method of claim 1, further comprising stabilizing the amount of power supplied by the engine to drive the TRS by applying the equation to a control loop.

12. The method of claim 11, wherein the control loop is a proportional-integral-derivative (PID) control loop.

13. The method of claim 1, wherein the components of the TRS include one or more of a compressor, a condenser, an evaporator, and an alternator.

14. A system of automatically controlling an amount of active engine power supplied by an engine to a transport refrigeration system (TRS), the system comprising:
a TRS controller configured to determine a maximum allowable amount of power supplied by the engine for operating the TRS,
the TRS controller configured to estimate an engine load of the engine by summing up system loads demanded by components of the TRS,
the TRS controller configured to obtain a difference between the maximum allowable amount of power supplied by the engine and the engine load, and
the TRS controller configured to adjust the engine load based on the difference between the maximum allowable amount of power supplied by the engine and the engine load.

15. The system of claim 14, further comprising a measurement unit configured to measure revolutions per minute (RPM) of the engine, the TRS controller determines the maximum allowable amount of power at the measured RPM, and to estimate the engine load at the measured RPM.

16. The system of claim 15, wherein the measurement unit includes one or more sensors configure to measure real-time system load parameters, and the TRS controller estimates the engine load based on measure real-time system load parameters.
